(19) United States
(12) Patent Application Publication
(10) Pub. No.: US 2003/0222740 A1
(43) Pub. Date: Dec. 4, 2003

(54) Latching micro-magnetic switch with improved thermal reliability

(75) Inventors: Meichun Ruan, Tempe, AZ (US); Jun Shen, Phoenix, AZ (US); Gordon Tam, Gilbert, AZ (US)

Correspondence Address: STERNE, KESSLER, GOLDSTEIN & FOX PLLC, 1100 NEW YORK AVENUE, N.W., WASHINGTON, DC, 20005, US

(73) Assignee: Microlab, Inc.

(21) Appl. No.: 10/390,164

(22) Filed: Mar. 18, 2003

Related U.S. Application Data
(60) Provisional application No. 60/364,617, filed on Mar. 18, 2002.

(51) Int. Cl. H01H 51/22

(52) U.S. Cl. 335/78

(57) ABSTRACT

A micro-magnetic switch includes a permanent magnet and a supporting device having contacts coupled thereto and an embedded coil. The supporting device can be positioned proximate to the magnet. The switch also includes a cantilever coupled at a central point to the supporting device. The cantilever has a conducting material coupled proximate an end and on a side of the cantilever facing the supporting device and having a soft magnetic material coupled thereto. During thermal cycling the cantilever can freely expand based on being coupled at a central point to the supporting device, which substantially reduces coefficient of thermal expansion differences between the cantilever and the supporting device.

### CROSS REFERENCE TO RELATED APPLICATIONS

This application claims benefit under 35 U.S.C. 119(e) to U.S. Prov. App. No. 60/364,617, filed Mar. 18, 2002, which is incorporated by reference herein in its entirty.

### BACKGROUND OF THE INVENTION

1. Field of the Invention

The present invention relates to electronic switches. More specifically, the present invention relates to latching micro-magnetic switches with structures having improved thermal and contact reliability.

2. Background Art

Switches are typically electrically controlled two-state devices that open and close contacts to effect operation of devices in an electrical or optical circuit. Relays, for example, typically function as switches that activate or de-activate portions of electrical, optical or other devices. Relays are commonly used in many applications including telecommunications, radio frequency (RF) communications, portable electronics, consumer and industrial electronics, aerospace, and other systems. More recently, optical switches (also referred to as “optical relays” or simply “relays” herein) have been used to switch optical signals (such as those in optical communication systems) from one path to another.

Although the earliest relays were mechanical or solid-state devices, recent developments in micro-electro-mechanical systems (MEMS) technologies and microelectronics manufacturing have made micro-electrostatic and micro-magnetic relays possible. Such micro-magnetic relays typically include an electromagnet that energizes an armature to make or break an electrical contact. When the magnet is de-energized, a spring or other mechanical force typically restores the armature to a quiescent position. Such relays typically exhibit a number of marked disadvantages, however, in that they generally exhibit only a single stable output (i.e. the quiescent state) and they are not latching (i.e. they do not retain a constant output as power is removed from the relay). Moreover, the spring required by conventional micro-magnetic relays may degrade or break over time.

Another micro-magnetic relay includes a permanent magnet and an electromagnet for generating a magnetic field that intermittently opposes the field generated by the permanent magnet. This relay must consume power in the electromagnet to maintain at least one of the output states. Moreover, the power required to generate the opposing field would be significant, thus making the relay less desirable for use in space, portable electronics, and other applications that demand low power consumption.

A bi-stable, latching switch that does not require power to hold the states is therefore desired. Such a switch should also be reliable, simple in design, low-cost and easy to manufacture, and should be useful in optical and/or electrical environments.

### BRIEF SUMMARY OF THE INVENTION

The latching micro-magnetic switch of the present invention can be used in a plethora of products including household and industrial appliances, consumer electronics, military hardware, medical devices and vehicles of all types, just to name a few broad categories of goods. The latching micro-magnetic switch of the present invention has the advantages of compactness, simplicity of fabrication, and has good performance at high frequencies.

Embodiments of the present invention provide a micro-magnetic switch including a permanent magnet and a supporting device having contacts coupled thereto and an embedded coil. The supporting device can be positioned proximate to the magnet. The switch also includes a cantilever coupled at a central point to the supporting device. The cantilever has a conducting material coupled proximate an end and on a side of the cantilever facing the supporting device and having a soft magnetic material coupled thereto. During thermal cycling the cantilever can freely expand based on being coupled at a central point to the supporting device, which substantially reduces coefficient of thermal expansion differences between the cantilever and the supporting device.

In one aspect of the present invention the switch also includes a metal layer coupled to the supporting device and an insulating layer formed on the metal layer, wherein the central point of the cantilever is coupled to the insulating layer.

In on aspect of the present invention the switch also includes a high permeability layer formed between the metal layer and the supporting device.

In one aspect of the present invention the contacts can comprise first and second spaced input contacts and first and second spaced output contacts, such that the conducting material interacts with both contacts substantially simultaneously, which balances an external actuation force.

In one aspect of the present invention the cantilever can include a spring between the central point and first and second end points.

In one aspect of the present invention the cantilever can include two springs between the central point and each of first and second end points.

In one aspect of the present invention the cantilever can be coupled via first and second spaced areas of the central point to the supporting structure.

### BRIEF DESCRIPTION OF THE FIGURES

The above and other features and advantages of the present invention are hereinafter described in the following detailed description of illustrative embodiments to be read in conjunction with the accompanying drawing figures, wherein like reference numerals are used to identify the same or similar parts in the similar views.

FIGS. 1A and 1B are side and top views, respectively, of an exemplary embodiment of a latching micro-magnetic switch.

FIG. 2 illustrates a hinged-type cantilever and a one-end-fixed cantilever, respectively.

FIG. 3 illustrates a cantilever body having a magnetic moment m in a magnetic field Hₒ.

FIGS. 4-14 illustrate various embodiments according to the present invention.

### DETAILED DESCRIPTION OF THE INVENTION

It should be appreciated that the particular implementations shown and described herein are examples of the invention and are not intended to otherwise limit the scope of the present invention in any way. Indeed, for the sake of brevity, conventional electronics, manufacturing, MEMS technologies and other functional aspects of the systems (and components of the individual operating components of the systems) may not be described in detail herein. Furthermore, for purposes of brevity, the invention is frequently described herein as pertaining to a micro-electronically-machined relay for use in electrical or electronic systems. It should be appreciated that many other manufacturing techniques could be used to create the relays described herein, and that the techniques described herein could be used in mechanical relays, optical relays or any other switching device. Further, the techniques would be suitable for application in electrical systems, optical systems, consumer electronics, industrial electronics, wireless systems, space applications, or any other application. Moreover, it should be understood that the spatial descriptions (e.g. “above”, “below”, up “down”, etc.) made herein are for purposes of illustration only, and that practical latching relays may be spatially arranged in any orientation or manner. Arrays of these relays can also be formed by connecting them in appropriate ways and with appropriate devices.

Principle of Operation

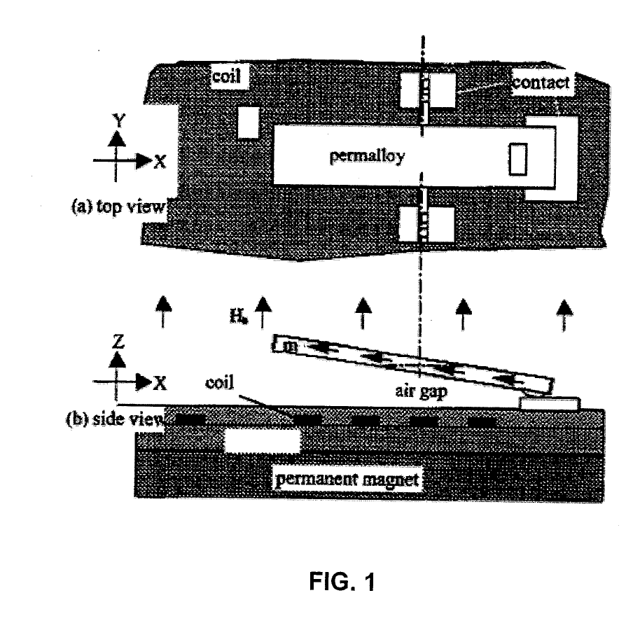

The basic structure of the microswitch is illustrated in FIGS. 1A and 1B, which include a top view and a cross sectional view, respectively. The device (i.e., switch) comprises a cantilever 102, a planar coil 104, a permanent magnet 106, and plural electrical contacts 108/110. The cantilever 102 is a multi-layer composite consisting, for example, of a soft magnetic material (e.g., NiFe permalloy) on its topside and a highly conductive material, such as Au, on the bottom surface. The cantilever 102 can comprise additional layers, and can have various shapes. The coil 104 is formed in a insulative layer 112, on a substrate 114.

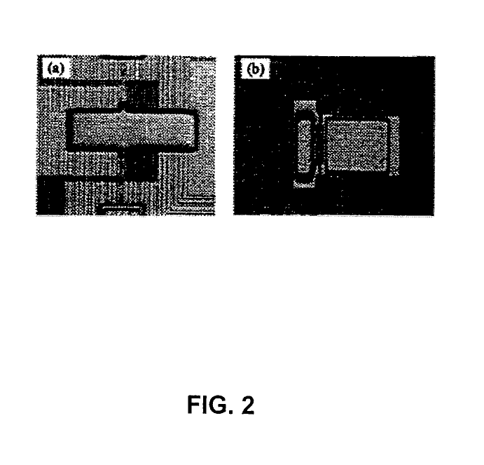

In one configuration, the cantilever 102 is supported by lateral torsion flexures 116 (see FIGS. 1 and 2, for example). The flexures 116 can be electrically conductive and form part of the conduction path when the switch is closed. According to another design configuration, a more conventional structure comprises the cantilever fixed at one end while the other end remains free to deflect. The contact end (e.g., the right side of the cantilever) can be deflected up or down by applying a temporary current through the coil. When it is in the “down” position, the cantilever makes electrical contact with the bottom conductor, and the switch is “on” (also called the “closed” state). When the contact end is “up”, the switch is “off” (also called the “open” state). The permanent magnet holds the cantilever in either the “up” or the “down” position after switching, making the device a latching relay. A current is passed through the coil (e.g., the coil is energized) only during a brief period of time to transistion between the two states.

(i) Method to Produce Bi-Stability

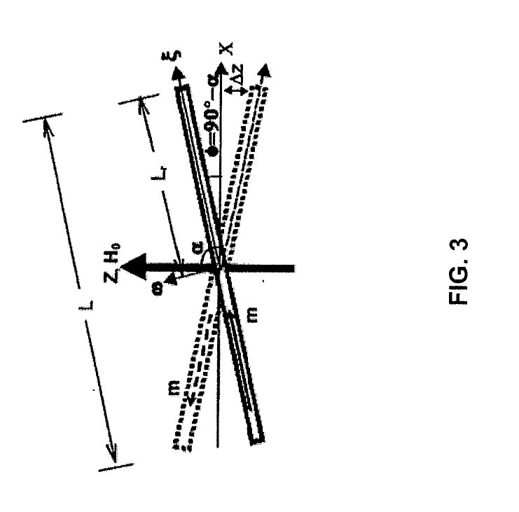

The by which bi-stability is produced is illustrated with reference to FIG. 3. When the length L of a permalloy cantilever 102 is much larger than its thickness t and width (w, not shown), the direction along its long axis L becomes the preferred direction for magnetization (also called the “easy axis”). When such a cantilever is placed in a uniform permanent magnetic field, a torque is exerted on the cantilever. The torque can be either clockwise or counterclockwise, depending on the initial orientation of the cantilever with respect to the magnetic field. When the angle (α) between the cantilever axis (ξ) and the external field (H₀) is smaller than 90°, the torque is counterclockwise; and when a is larger than 90°, the torque is clockwise. The bi-directional torque arises because of the bi-directional magnetization (by H₀) of the cantilever (from left to right when α<90°, and from right to left when α>90°). Due to the torque, the cantilever tends to align with the external magnetic field (H₀). However, when a mechanical force (such as the elastic torque of the cantilever, a physical stopper, etc.) preempts to the total realignment with H₀, two stable positions (“up” and “down”) are available, which forms the basis of latching in the switch.

(ii) Electrical Switching

If the bi-directional magnetization along the easy axis of the cantilever arising from H₀ can be momentarily reversed by applying a second magnetic field to overcome the influence of (H₀), then it is possible to achieve a switchable latching relay. This scenario is realized by situating a planar coil under or over the cantilever to produce the required temporary switching field. The planar coil geometry was chosen because it is relatively simple to fabricate, though other structures (such as a wrap-around, three dimensional type) are also possible. The magnetic field (Hcoil) lines generated by a short current pulse loop around the coil. It is mainly the ξ-component (along the cantilever, see FIG. 3) of this field that is used to reorient the magnetization in the cantilever. The direction of the coil current determines whether a positive or a negative 4-field component is generated. Plural coils can be used. After switching, the permanent magnetic field holds the cantilever in this state until the next switching event is encountered. Since the ξ-component of the coil-generated field (Hcoil-ξ) only needs to be momentarily larger than the ξ-component (H₀ξ-H₀ cos(α)=H₀ sin((φ), α=90°−φ) of the permanent magnetic field and φ is typically very small (e.g., φ≦5°), switching current and power can be very low, which is an important consideration in micro relay design.

The operation principle can be summarized as follows: A permalloy cantilever in a uniform (in practice, the field can be just approximately uniform) magnetic field can have a clockwise or a counterclockwise torque depending on the angle between its long axis (easy axis, L) and the field. Two bi-stable states are possible when other forces can balance die torque. A coil can generate a momentary magnetic field to switch the orientation of magnetization along the cantilever and thus switch the cantilever between the two states.

The above-described micro-magnetic latching switch is further described in U.S. Pat. No. 6,469,602 (titled Electronically Switching Latching Micromagnetic Relay And Method of Operating Same). This patent provides a thorough background on micro-magnetic latching switches and is incorporated herein by reference in its entirety.

Although latching micro-magnetic switches are appropriate for a wide range of signal switching applications, reliability due to thermal cycling is an issue.

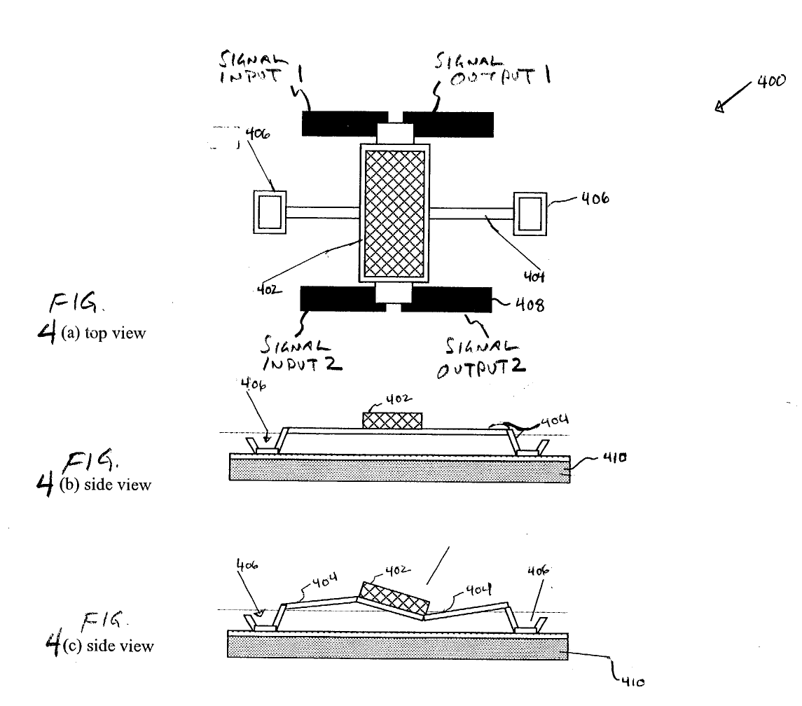

FIGS. 4A-C illustrate a known micro device structure 400 having a movable cantilever 402 supported by two torsion flexures 404, which are fixed by fixing devices (e.g., anchors) 406. Cantilever 402 interacts with contacts 408 on substrate 410. The cantilever 402 can be flat (see FIG. 4B) as fabricated. However, due to the difference between coefficients of thermal expansion (CTE) of the cantilever 402 and a substrate 410, the substrate 410 and a cantilever assembly, which includes cantilever 402 and the torsion flexures 404, can expand or shrink differently when temperature changes. Because the cantilever assembly is fixed by anchors 406 at the two ends, the cantilever assembly can deform and even buckle (see FIG. 4C) when the fabricated device 400 goes through temperature cycling, which can make the device 400 fail or malfunction. To pass a signal from the input 1 to the output 1, the cantilever 402 needs to touch both the input 1 bottom pad 408 and the output 1 pad 408. Therefore, two physical contacts of input 1 versus cantilever and cantilever versus output 1 are made to achieve the electrical path.

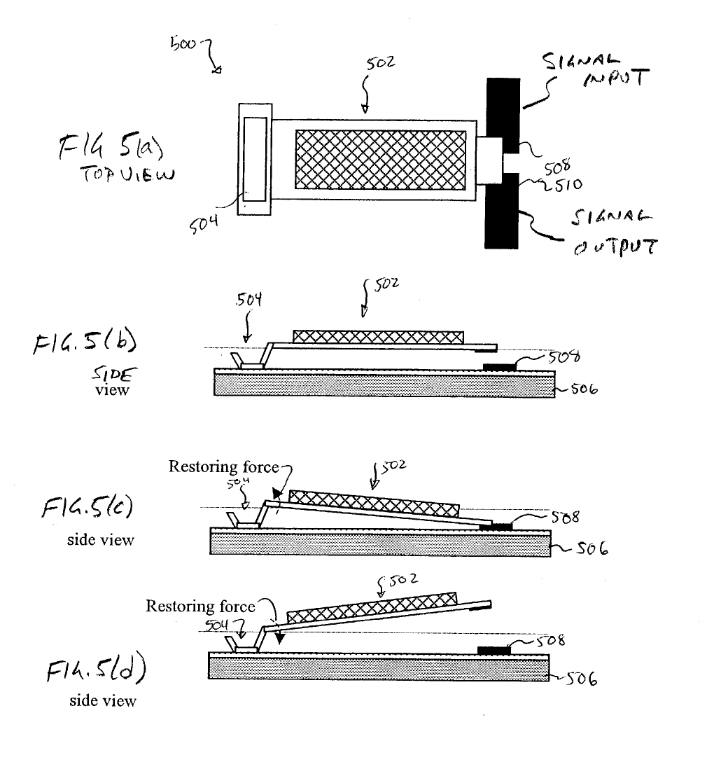

The device 500 of FIG. 5 also has a movable cantilever 502 supported by a fixed device 502 coupled to a substrate 506 on one end. In this design, the cantilever 502 can freely expand on one end and thus will not have the problem encountered by the design in FIG. 4. However, this design is not ideal in the operation. When the cantilever 502 is pulled down by a suitable actuation mechanism (e.g., magnetic, electrostatic, thermal, etc.), its open end touches down on the bottom contact 508. In order to have maximum contact force, it is preferred to have a minimum mechanical restoring force (dashed arrows). When the cantilever 502 is pushed up by an opposite force (e.g., magnetic, electrostatic, thermal, etc.), it has to rely on the mechanical restoring force in the cantilever 502 to counter balance the external force to stay in the up position. So the requirement on the strength of the restoring forces in the “down” and “up” states can be contradictory, and the performance of the micro device 500 is compromised. In this design, to pass a signal from the input to the output, the cantilever 502 needs to touch both the input bottom pad 508 and the output pad 510. Therefore, two physical contacts of input versus cantilever and cantilever versus output are made to achieve the electrical path.

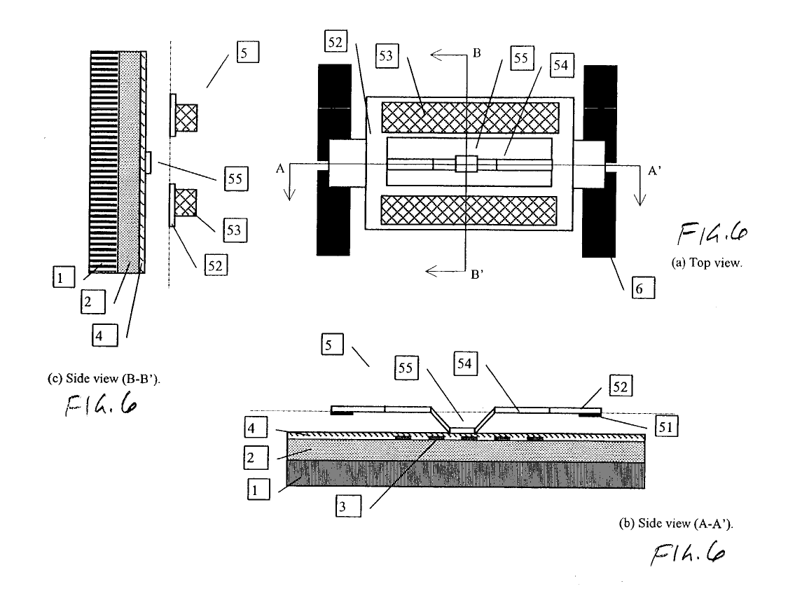

FIG. 6 illustrates an embodiment of the present invention. The device comprises bottom conductors (6) fabricated on a suitable substrate (2) covered with an optional dielectric material (4), an embedded coil (3), a cantilever (5) supported by springs (54) with a single stage (55) on the substrate. The cantilever (5) has a bottom conducting layer (51), a thin structural material (52), and thick soft magnetic materials (53). A permanent magnet (3) provides a static magnetic field approximately perpendicular to the longitudinal axis of the cantilever. The cantilever can rotate about the torsion spring under external influences (e.g., magnetic fields). Since this inventive design has only one fixed stage on the substrate, the problem due to the CTE difference between the cantilever and the substrate is at least partially solved because the cantilever can freely expand on its free end during the thermal cycling. Also, the cantilever has two contact ends to counter balance the external actuation force and thus does not rely on the mechanical restoring force in the torsion springs (54) to counter balance the external actuation force. Thus, the torsion spring can be designed to minimize the restoring force and maximize the contact force.

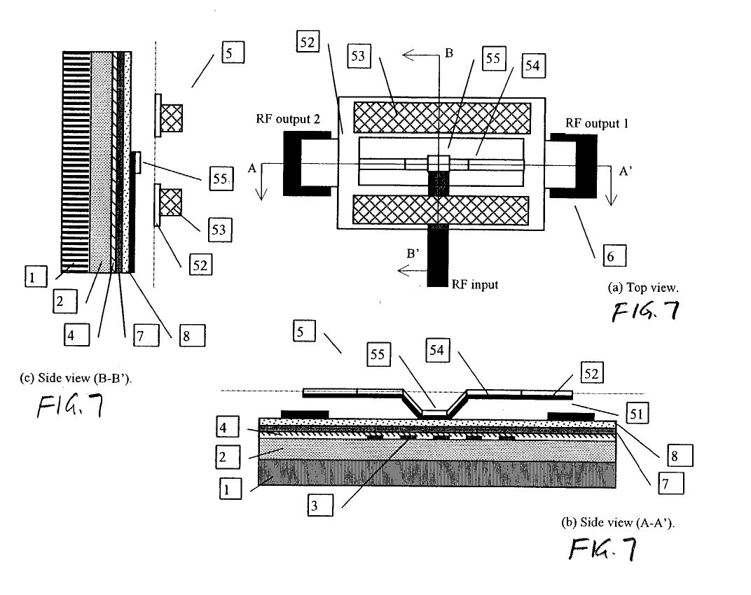

FIG. 7 illustrates a further embodiment of the present invention, which includes a metal layer (RF ground plane [7]) above the coil and below the cantilever and the RF signal line. The effect of the ground plane is to shield the RF signal from the driving coil signals. The device comprises bottom conductors (6) fabricated on a suitable insulator (8) coated on a metal layer (7), a dielectric layer (4), an embedded coil (3), a cantilever (5) supported by springs (54) with a single stage (55) on the substrate (2). The cantilever (5) has a bottom conducting layer (51), a thin structural material (52), and thick soft magnetic materials (53). A permanent magnet (1) provides a static magnetic field approximately perpendicular to the longitudinal axis of the cantilever. The cantilever can rotate about the torsion spring under external influences (e.g., magnetic fields). Since this inventive design has only one contact on each side, it reduces the requirement of the prior art from making two contacts at the same time down to making just one contact. Therefore, it improves the contact reliability. Also metal layer (7), which serves as a ground plane, shields the influence of the coil to the signal in the RF application. The signal travels from the input metal trace (not shown in the figure) to the stage (55), through spring (54), conductor (51) to the output pad (6). Conductor (51) can also be conformably extended or fabricated under the spring(54) and under the stage (55).

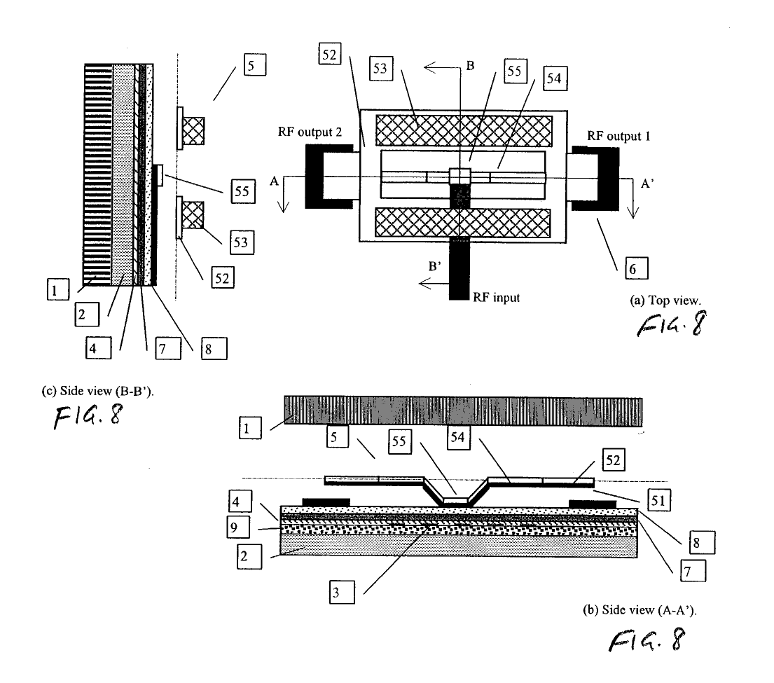

FIG. 8 illustrates a further embodiment of the present invention. The device of FIG. 8 comprises bottom conductors (6) fabricated on a suitable insulator (8) coated on a metal layer (7), a dielectric layer (4), an embedded coil (3), a high-permeability material (e.g., permalloy) layer (9), a cantilever (5) supported by springs (54) with a single stage (55) on the substrate (2). The cantilever (5) has a bottom conducting layer (51), a thin structural material (52), and thick soft magnetic materials (53). A permanent magnet (1) provides a static magnetic field approximately perpendicular to the longitudinal axis of the cantilever. The high-permeability material layer (9) forms a magnetic dipole with the permanent magnet (1). The cantilever can rotate about the torsion spring under external influences (e.g., magnetic fields). Since this inventive design has only one contact on each side, it reduces the requirement of the prior art from making two contacts at the same time down to making just one contact. Therefore, it improves the contact reliability. Also metal layer (7), which serves as a ground plane, shields the influence of the coil to the signal in the RF application. The signal travels from the input metal trace (not shown in the figure) to the stage (55), through spring (54), conductor (51) to the output pad(6). Conductor (51) can also be conformably extended or fabricated under the spring (54) and under the stage (55).

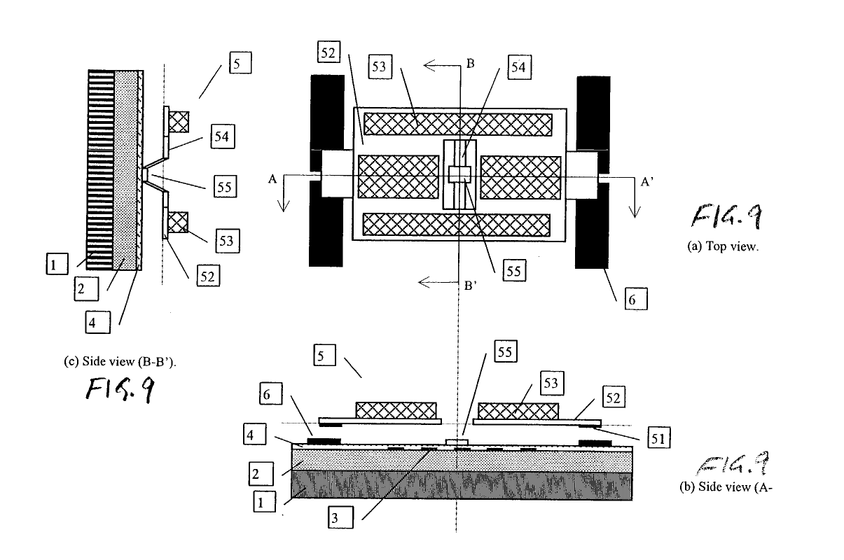

FIG. 9 illustrates a further embodiment of the present invention, and comprises bottom conductors 6 fabricated on a suitable substrate (2) covered with an optional dielectric material (4), an embedded coil (3), a cantilever (5) supported by torsion springs (54) with a single stage (55) on the substrate. The cantilever (5) has a bottom conducting layer (51), a thin structural material (52), and thick soft magnetic materials (53). A permanent magnet (3) provides a static magnetic field approximately perpendicular to the longitudinal axis of the cantilever. The cantilever can rotate about the torsion spring under external influences (e.g., magnetic fields). Since this new design has only one fixed stage on the substrate, the problem due to the CTE difference between the cantilever and the substrate is at least partially solved because the cantilever can freely expand on its free end during the thermal cycling. Also, the cantilever has two contact ends to counterbalance the external actuation force and thus does not rely on the mechanical restoring force in the torsion springs (54) to counter balance the external actuation force. So the torsion spring can be designed to minimize the restoring force and maximize the contact force.

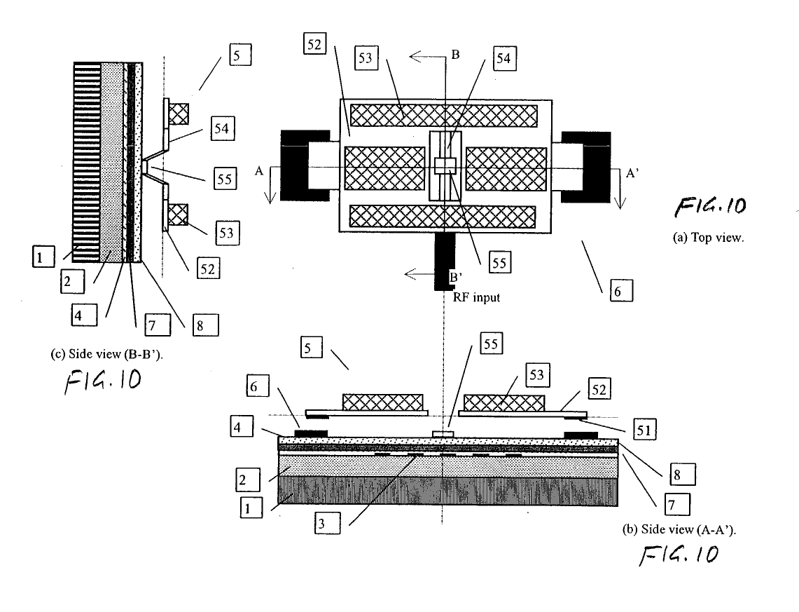

FIG. 10 illustrates a further embodiment of the present invention. The device comprises bottom conductors (6) fabricated on a suitable insulator (8) coated on a metal layer (7), a dielectric layer (4), an embedded coil (3), a cantilever (5) supported by springs (54) with a single stage (55) on the substrate (2). The cantilever (5) has a bottom conducting layer (51), a thin structural material (52), and thick soft magnetic materials (53). A permanent magnet (1) provides a static magnetic field approximately perpendicular to the longitudinal axis of the cantilever. The cantilever can rotate about the torsion spring under external influences (e.g., magnetic fields). The number of contacts is reduced as described above. Metal layer (7), which serves as a ground plane, shields the influence of the coil to the signal in the RF application. The signal travels from the input metal trace (not shown in the figure) to the stage (55), through spring (54), conductor (51) to the output pad(6). Conductor (51) can also be conformably extended or fabricated under the spring(54) and under the stage (55), as shown in FIG. 3.

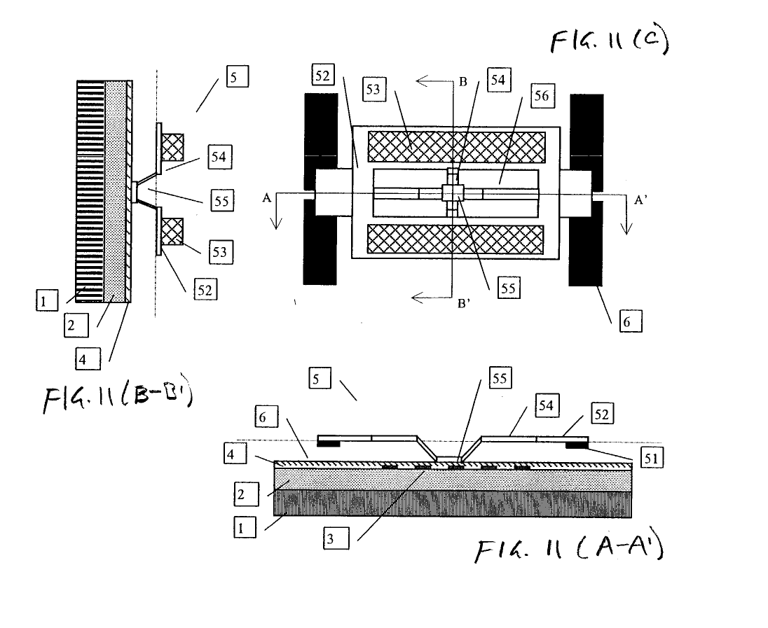

FIG. 11 illustrates an embodiment of the present invention with x-y springs (B-B′ x-orientation: 54, and A-A′ y-orientation: 56). In this case, the two springs can be made of different materials. For example, spring 54 can be made of a mechanically stronger material (e.g., Ni) to support the cantilever, while the spring 56 can be made of a more conductive material (e.g., Au) for electrical conduction.

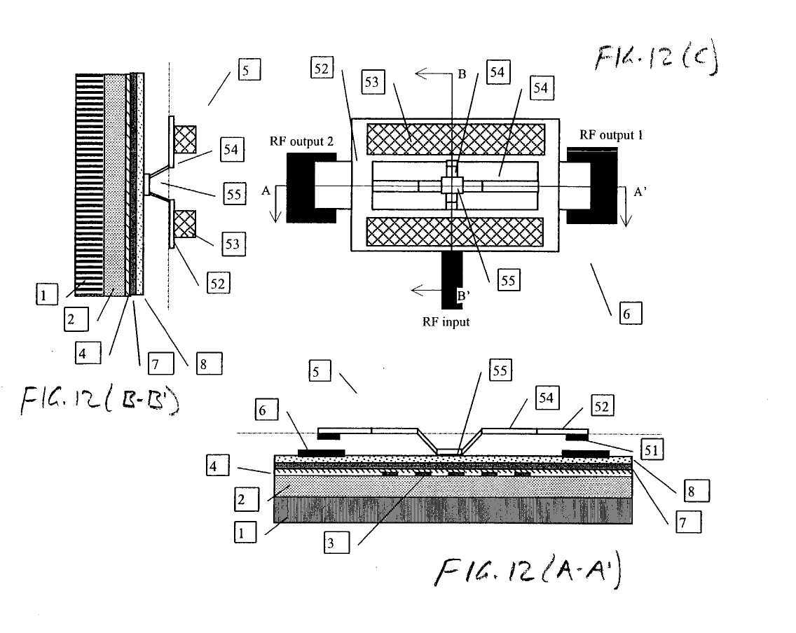

FIG. 12 illustrates a further embodiment of the present invention with x-y springs.

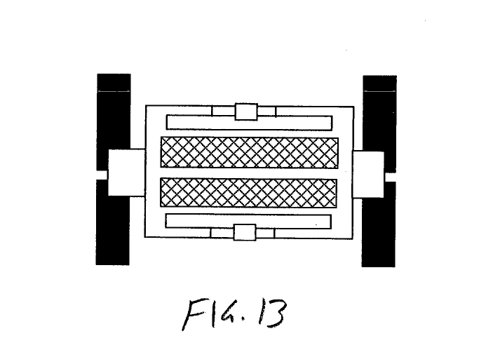

FIG. 13 illustrates an embodiment of the present invention with two stages. In this design, even though there are two stages on the two sides, the two ends of the cantilever are not fixed to the substrate and are allow to expand both in the x and y directions.

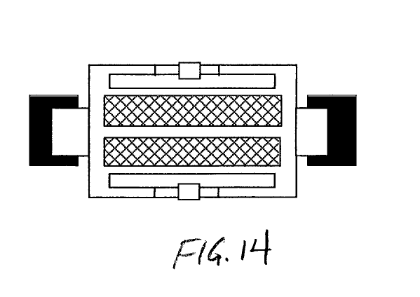

FIG. 14 illustrates a further embodiment of the present invention with two stages. In this design, even though there are two stages on the two sides, the two ends of the cantilever are not fixed to the substrate and are allow to expand both in the x and y directions.

### CONCLUSION

The corresponding structures, materials, acts and equivalents of all elements in the claims below are intended to include any structure, material or acts for performing the functions in combination with other claimed elements as specifically claimed. Moreover, the steps recited in any method claims may be executed in any order. The scope of the invention should be determined by the appended claims and their legal equivalents, rather than by the examples given above. Finally, it should be emphasized that none of the elements or components described above are essential or critical to the practice of the invention, except as specifically noted herein.

What is claimed is:

1. A micro-magnetic switch comprising:
a permanent magnet;
a supporting device having contacts coupled thereto and an embedded coil, the supporting device being positioned proximate to the magnet; and
a cantilever coupled to the supporting device at a location approximately at a central point of the cantilever, the cantilever having a conducting material coupled proximate an end and on a side of the cantilever facing the supporting device and having a soft magnetic material coupled thereto,
wherein during thermal cycling the cantilever can freely expand based on being coupled at a central point to the supporting device, which substantially reduces coefficient of thermal expansion differences between the cantilever and the supporting device.

2. The switch of claim 1, further comprising:
a metal layer coupled to the supporting device; and
an insulating layer formed on the metal layer, wherein the central point of the cantilever is coupled to the insulating layer.

3. The switch of claim 1, further comprising:
a high permeability layer formed between the metal layer and the supporting device.

4. The switch of claim 1, wherein the contacts comprise first and second spaced input contacts and first and second spaced output contacts, such that the conducting material interacts with both contacts substantially simultaneously, which balances an external actuation force.

5. The switch of claim 1, wherein the cantilever comprises a spring between the central point and first and second end points.

6. The switch of claim 1, wherein the cantilever comprises two springs between the central point and each of first and second end points.

7. The switch of claim 1, wherein the cantilever is coupled via first and second spaced areas of the central point to the supporting structure.
